(19) United States
(12) Patent Application Publication
(10) Pub. No.: US 2013/0314013 A1
(43) Pub. Date: Nov. 28, 2013

(54) Motor Driving Control Apparatus

(71) Applicant: Hitachi Automotive Systems, Ltd., Hitachinaka-shi (JP)

(72) Inventors: Toshiyuki AJIMA, Tokai-mura (JP); Takuro KANAZAWA, Hitachinaka-shi (JP); Hiroshi AOYAGI, Isesaki-shi (JP); Yawara KATO, Isesaki-shi (JP); Tomio SAKASHITA, Isesaki-shi (JP); Atsushi YOSHITAKE, Ebina-shi (JP)

(73) Assignee: Hitachi Automotive Systems, Ltd., Hitachinaka-shi (JP)

(21) Appl. No.: 13/900,729

(22) Filed: May 23, 2013

(30) Foreign Application Priority Data
May 25, 2012 (JP) 2012-119244

(51) Int. Cl. H02P 23/00

(52) U.S. Cl. CPC H02P 23/00
USPC 318/400.21

(57) ABSTRACT

In related art technique, an average neutral point voltage is detected via a low-pass filter. Time constant of the low-pass filter must be set to cover the entire output frequency band of an inverter and voltage fluctuation due to modulated signal must be separated from that due to a short circuit to ground. According to the present invention, whether abnormality such as a short circuit to ground or to supply occurs in output lines can be determined based on an actual neutral point voltage of a motor, which changes in a stepwise fashion in conformity to a PWM pulse pattern output by an inverter device, and a normal neutral point voltage which depends on a PWM pattern output by the inverter device. Highly reliable abnormality detection in accordance with the waveform of the neutral point voltage and stable abnormality detection not depending on the inverter output frequency are feasible.

### CLAIM OF PRIORITY

The present application claims priority from Japanese Patent applications serial No. 2012-119244, filed on May 25, 2012, the respective contents of which are hereby incorporated by reference into this application.

### FIELD OF THE INVENTION

The present invention relates to a motor driving control apparatus that controls operation of a motor and, in particular, to a motor driving control apparatus capable of detecting an abnormality in output lines from a unit generating a driving control signal for driving and controlling the motor up to the windings of the motor.

### BACKGROUND OF THE INVENTION

Generally, a power converter apparatus for driving and controlling a motor includes an inverter device, which is a unit generating a driving control signal, that receives DC power from a DC power supply and generates AC power and a control device for controlling this inverter device.

AC power produced by the power converter apparatus is supplied to a motor (e.g., a three-phase synchronous motor) and the motor generates running torque depending on the AC power supplied to it.

Such a power converter apparatus is used to drive and control various types of motors, for example, mounted in automobiles. By way of example, a power converter apparatus is used in a motorized power steering equipment which is a motorized steering gear of an automobile, an automobile driving motor equipment which drives the wheels of an automobile, or the like. The power converter apparatus is to drive and control the system equipment in such a manner that it receives DC power from a secondary battery mounted in the automobile, converts it to AC power, and supplies the AC power to the corresponding motor. Further description is omitted here, because how the power converter apparatus works is well known.

For the inverter device which is the unit generating a driving control signal for use in the foregoing power converter apparatus, it is demanded to detect an abnormality such as a short circuit to ground or a short circuit to supply in output lines including electrical wiring leads from switching elements of the inverter device up to the motor and the windings of the motor and stop the motor and the inverter device safely.

To comply with such a demand, in Japanese Patent Laid-open No. 2006-81327 (Patent Document 1), a technique is described that detects a neutral point voltage of a motor via a filter having a low pass characteristic lower than a PWM carrier frequency and determines an abnormality if a detected output voltage value is less than a predetermined voltage value.

The technique disclosed in Patent Document 1 obtains neutral point voltages by adding voltage values detected on the respective lines for three phases of the inverter device, detects an average value of the neutral point voltages via a low-pass filter lower than a PWM frequency, and compares this average value with a predetermined threshold value to detect an abnormality such as a short circuit to ground of the motor.

However, in addition to a harmonic component produced by PWM modulation in the inverter device, a harmonic component depending on a modulated signal is superimposed on a neutral point voltage of the motor. In particular, for a modulated signal with a modulation factor of 1.0 or more of the inverter and including a third harmonic and a 180-degree square wave modulated signal, a voltage fluctuation synchronous with an output frequency of the inverter is superimposed on a neutral point voltage of the motor.

Therefore, as the characteristic of the low-pass filter, its time constant needs to be set to cover the entire output frequency band of the inverter, and a voltage fluctuation due to an inverter modulation scheme needs to be separated from a voltage fluctuation due to a short circuit to ground. This resulted in a problem in which it is unachievable to make a correct detection of an abnormality such as a short circuit to ground while the motor is operating.

An object of the present invention is to provide a motor driving control apparatus capable of correctly detecting an abnormality in the output lines from the switching elements of the inverter device, extending to include the windings of the motor, regardless of a modulation scheme of the inverter device, at least while the motor is operating.

### SUMMARY OF THE INVENTION

A feature of the present invention resides in that a determination is made as to whether an abnormality occurs in the output lines, based on an actual neutral point voltage of a motor, which changes in a stepwise fashion in conformity to a PWM pulse pattern output by an inverter device, and a normal neutral point voltage which depends on a PWM pattern output by the inverter device.

According to the present invention, whether an abnormality such as a short circuit to ground or a short circuit to supply occurs in the output lines can be determined from a normal neutral point voltage which depends on a PWM pulse pattern (output voltage vector) according to modulated waves and an actual neutral point voltage which depends on a PWM pulse pattern. Thus, highly reliable abnormality detection in accordance with the waveform of the neutral point voltage is feasible. Also, stable abnormality detection not depending on the inverter output frequency is feasible.

### BRIEF DESCRIPTION OF THE DRAWINGS

FIG. 1 is a schematic diagram depicting a configuration of a motor driving control apparatus which is an exemplary embodiment of the present invention.

FIG. 2 is a diagram illustrating output voltage vectors representing inverter outputs in the motor driving control apparatus depicted in FIG. 1.

FIG. 3 is a set of waveform diagrams presenting waveforms for explaining a detecting operation with regard to a U phase in the motor driving control apparatus depicted in FIG. 1.

FIG. 4 is a flowchart diagram illustrating a control flow process by which an abnormality determiner of the motor driving control apparatus depicted in FIG. 1 determines whether an abnormality occurs.

FIG. 5 is a set of waveform diagrams presenting waveforms for explaining the detecting operation with regard to the U phase, when a modified modulation factor is applied, in the motor driving control apparatus depicted in FIG. 1.

FIG. 6 is a set of waveform diagrams presenting waveforms for explaining the detecting operation with regard to the U phase, when a modified modulation factor is applied, in the motor driving control apparatus depicted in FIG. 1.

FIG. 7 is a set of waveform diagrams presenting waveforms for explaining the detecting operation with regard to the U phase, when a modified modulation factor is applied, in the motor driving control apparatus depicted in FIG. 1.

FIG. 8 is a schematic diagram depicting a configuration of a motor driving control apparatus which is an exemplary embodiment of the present invention.

FIG. 9 is a waveform diagram presenting a waveform for explaining the detecting operation with regard to the U phase in the motor driving control apparatus depicted in FIG. 8.

FIG. 10 is a schematic diagram of a motorized power steering equipment to which the motor driving control apparatus which is an exemplary embodiment of the present invention is applied.

FIG. 11 is a schematic diagram of a hybrid automobile system to which the motor driving control apparatus which is an exemplary embodiment of the present invention is applied.

FIG. 12 is a schematic diagram of a motorized pump system to which the motor driving control apparatus which is an exemplary embodiment of the present invention is applied.

### DETAILED DESCRIPTION OF PREFERRED EMBODIMENTS

In the following, a motor driving control apparatus as an exemplary embodiment of the present invention will be described in detail by way of the drawings.

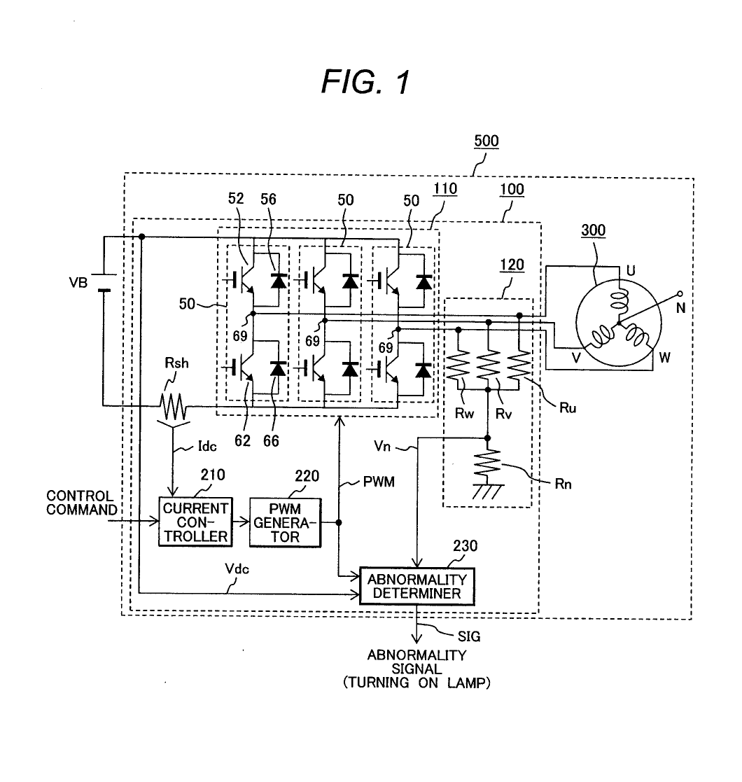

FIG. 1 presents a first embodiment of the present invention and depicts a configuration of a motor driving control apparatus which is used as an example in a motorized power steering equipment.

In FIG. 1, there is presented an exemplary embodiment in which a unit generating a driving control signal 100 (hereinafter referred to as an inverter device) of the motorized power steering equipment 500 monitors a neutral point voltage of a motor and detects if abnormality, which is a short circuit to ground in this context, occurs in an output line from a switching element of the inverter device, extending to include windings of the motor. In this example, a power converter apparatus and a motor are presented, but other constituent parts constituting the steering equipment are omitted.

The motorized power steering equipment 500 includes the motor 300 and the inverter device 100. The inverter device 100 includes a current controller 210, a PWM generator 220, an inverter circuit 110, a neutral point voltage detecting circuit 120, and an abnormality determiner 230. In case an abnormality occurs in the output line, the abnormality determiner 230 operates to generate an abnormality signal and issue an alert such as turning on a lamp.

A battery power supply VB is the source of DC voltage of the inverter device 100. A DC voltage Vdc of the battery power supply VB is converted by the inverter circuit 110 in the inverter device 100 to a three-phase alternating current (AC) with a variable voltage and a variable frequency which is applied to the motor 300.

The motor 300 is a three-phase motor that is driven to run by being supplied with three-phase AC power. The three-phase motor 300 may be a permanent magnetic motor, an induction motor, or an SR motor.

The inverter device 100 has a current control function for controlling a rotational output of the motor 300. Specifically, the current controller 210 detects current values for three phases (Iu, Iv, and Iw) to be applied to the motor from a DC current value Idc detected by a current detector Rsh provided on a DC bus from a negative electrode of the battery in the inverter device 100 and a PWM pulse pattern. The current controller 210 generates a voltage command so that there is no error between the thus detected current values and values commanded by a control command such as a current control command and outputs the voltage command to the PWM generator 220. The current controller 210 may use current detection values (Id and Iq) which are obtained by d-q transformation using the current values for three phases to be applied to the motor and a rotational position θ of the motor.

The PWM generator 220 performs pulse width modulation (PWM) according to voltage command values (Vu*, Vv*, and Vw*) generated by the current controller 210, thus generating a drive signal PWM by which it controls on/off of semiconductor switching elements in the inverter circuit 110 and adjusts an output voltage.

Then, an outlined structure of the inverter circuit 110 is described. In the following description, an insulated gate bipolar transistor (IGBT) is used as a semiconductor element for power switching and it is to be abbreviated to IGBT.

In the inverter circuit 110, a serial circuit 50 in which upper and lower arms are serially connected is configured with an IGBT 52 and a diode 56 which operate as an upper arm and an IGBT 62 and a diode 66 which operate as a lower arm. The inverter circuit 101 is provided with three such serial circuits 50 respectively for three phases U, V, and W of AC power to be output.

These three phases correspond to the respective windings of three phases, i.e., the armature windings of the motor 300 in this embodiment. Each serial circuit 50 of upper and lower arms for each of the three phases outputs an AC current from its intermediate electrode 69. This intermediate electrode 69 is electrically connected to the corresponding winding of each phase of the motor 300 via an AC terminal. Wiring from this intermediate electrode 69, extending to include the winding, is referred to as an output line in the following description.

A corrector electrode of the IGBT 52 in the upper arm is electrically connected to a positive electrode of the battery power supply VB via a positive terminal. An emitter electrode of the IGBT 62 in the lower arm is electrically connected to a negative electrode of the battery power supply VB via a negative terminal.

Hence, driving of the IGBTs 52, 62 in the upper and lower arms of the inverter circuit 110 is controlled by an on/off signal (PWM signal) controlled by the PWM generator 220, as a result of which the motor 300 is driven to run.

The outlined structure of the inverter circuit 110 is as described above, but further description is omitted, because its structure is well known.

To control a rotational speed of the motor 300, it will be expedient to generate a voltage or current command to make the rotational speed ωr of the motor accord with a speed command from an higher level controller and feed back the voltage or current command.

Here are then described the neutral point voltage detecting circuit 120 and the abnormality determiner 230 which are a feature of the present invention. The neutral point voltage detecting circuit 120 detects output voltages for three phases of the inverter circuit 110 and generates a virtual neutral point voltage; besides, it divides the detected voltages to detect an average neutral point voltage value Vn.

In particular, resistors Ru, Rv, and Rw are respectively connected to the output lines for the respective phases between each intermediate electrode and each of the windings of the motor 300, here referring to FIG. 1. These resistors are grounded via a resistor Rn. Thus, voltage division by the resistor Rn can make it possible to detect a neutral point voltage as an average across the voltages for each phase.

Because the battery power supply VB for the motorized power steering equipment is as low as 12 V in this embodiment, the resistors Ru, Rv, and Rw are directly connected to the output lines for the respective phases. However, in a case in which a motor for driving the wheels is driven with a high voltage like a hybrid vehicle, it is desirable to detect a neutral point voltage by making current-to-voltage conversion indirectly through the use of a Hall element or the like.

The above-mentioned average neutral point voltage value Vn detected by the neutral point voltage detecting circuit 120 is normalized to a voltage level acceptable for processing by the abnormality determiner 230. For example, if the average neutral point voltage value Vn is processed digitally, it is divided so as to be at a level of 0 to 5 V corresponding to an input level for an A/D converter and a voltage signal thus divided and modified is used. The average neutral point voltage value Vn may be amplified by an operational amplifier and subjected to impedance conversion, and a resulting voltage may be applied.

The abnormality determiner 230 is provided with a function of detecting an abnormality in the output lines, depending on whether an average neutral point voltage value Vn detected by the neutral point voltage detecting circuit 120 is normal or depending on the degree to which the value Vn differs from a threshold value representing an average neutral point voltage value VN as designed (hereinafter referred to as a normal average neutral point voltage value VN).

A threshold value representing this normal average neutral point voltage value VN is adjusted depending on a PWM pattern which is fixed by the PWM generator 210. In particular, a threshold value is obtained by adjusting a voltage Vdc of the battery power supply VB depending on a PWM pattern. For example, one, two thirds, or one third times a voltage Vdc of the battery power supply VB depending on a PWM pattern may be used as a threshold value. In this embodiment, this threshold value is adjusted based on inverter output voltage vectors.

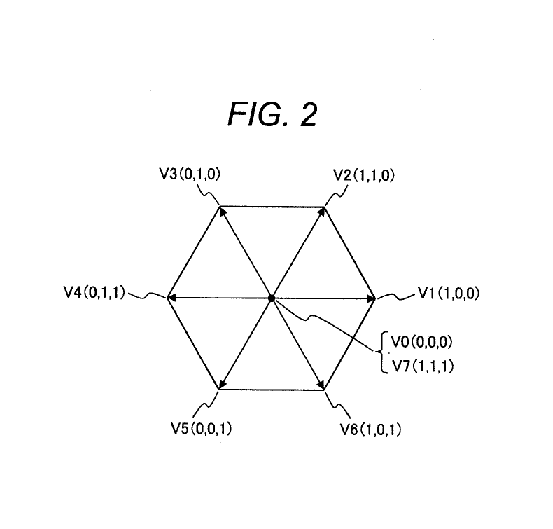

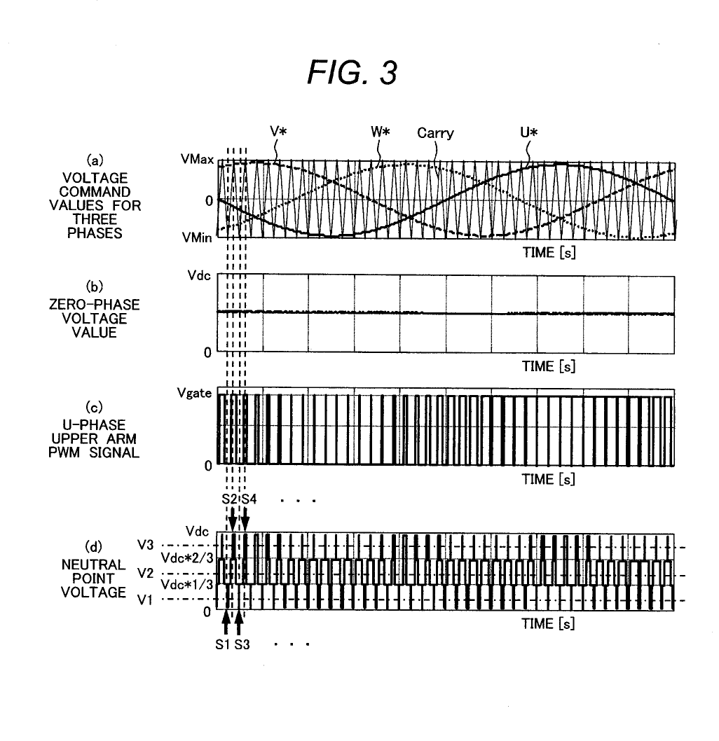

Next, output voltage vectors indicating outputs from the inverter circuit 110 in the first embodiment are described using FIG. 2. An operation of detecting an abnormality in the output lines in the first embodiment is described using FIG. 3.

Each of the output voltage vectors of the inverter circuit 110 presented in FIG. 2 represents a PWM pulse pattern of bits in order of the U phase, V phase, and W phase. Each bit is 1 when the corresponding upper arm element 52 of the inverter is on and 0 when the corresponding lower arm element 62 is on. The inverter 110 output voltage vector varies from vector V0 to vector V7 and there are two zero vectors, V0 (0, 0, 0) and V7 (1, 1, 1).

The present embodiment is arranged to determine the above-mentioned threshold value based on the output voltage vectors which are determined depending on a PWM pulse pattern. That is, a voltage that is determined by vector V7, a voltage that is determined by vectors V2, V4, and V6, a voltage that is determined by vectors V1, V3, and V5, and a voltage that is determine by vector V0 are used as levels that are used to set a threshold value.

Specifically, an average neutral point voltage value Vn that appears during operation of the motor is a voltage that changes in a stepwise fashion synchronously with a PWM pulse pattern. Thus, by comparing this average neutral point voltage value Vn with a normal average neutral point voltage value VN, determination can be made as to whether the motor operation is normal or an abnormality occurs.

When the output voltage vectors of the inverter circuit 110 are vectors V2, V4, and V6, the inverter circuit 110 output voltages for two of the three phases are a DC voltage Vdc of the battery power supply VB and the output voltage for the remaining one phase is 0 volt. In this case, a normal average neutral point voltage value VN becomes VN=Vdc×⅔.

When the output voltage vectors of the inverter circuit 110 are vectors V1, V3, and V5, the inverter circuit 110 output voltage for one of the three phases is a DC voltage Vdc of the battery power supply VB and the output voltages for the remaining two phases are 0 volt. In this case, a normal average neutral point voltage value VN becomes VN=Vdc×⅓.

When the output voltage vector of the inverter circuit is vector V0, all the output voltages for the three phases are 0 volt. Thus, a normal average neutral point voltage value VN becomes VN=0.

Likewise, when the output voltage vector of the inverter circuit is vector V7, all the output voltages for the three phases are a DC voltage Vdc of the battery power supply VB. Thus, a normal average neutral point voltage value VN becomes VN=Vdc.

In FIG. 3, a section (a) presents modulated waves (voltage command values) U*, V*, and W* of the inverter which are voltage command values for the three phases and a modulation factor is 1.0. A PWM carrier Carry of a triangle wave which is a carrier wave is also presented.

A section (b) presents a voltage waveform of a zero-phase voltage value which is superimposed on the modulated waves U*, V*, and W*. In a sinusoidal modulation, the zero-phase voltage is Vdc/2 volt.

A section (c) presents a U-phase upper arm PWM signal to drive the corresponding upper arm switching element IGBT 52 in the inverter circuit 110. A complementary signal for the U-phase upper arm PWM signal is a U-phase lower arm PWM signal. When the U-phase upper arm PWM signal is at a high level Vgate, the U-phase upper arm switching element IGBT 52 turns on and the inverter circuit output voltage becomes Vdc. Inversely, when the U-phase upper arm PWM signal is at a low level “0”, the U-phase lower arm switching element IGBT 62 turns on and the inverter output voltage becomes 0 volt.

Furthermore, a section (d) presents an average neutral point voltage value Vn changing synchronously with the PWM carrier Carry. Here is presented a voltage value at a neutral point N of the motor 300, changing in order from vector V0 to vector V7. This is an average combined voltage value of the output voltages Vu, Vv, and Vw of the inverter circuit 110 for the respective three phases, as is expressed in Equation (1) below. This is equivalent to an average neutral point voltage value Vn which is detected by the neutral point voltage detecting circuit 120.

Vn=(Vu+Vv+Vw)/3 (1)

Hence, this average neutral point voltage value Vn may be considered as the one detected by the neutral point voltage detecting circuit 120 described previously. This average neutral point voltage value Vn is a voltage that changes in a stepwise fashion synchronously with a PWM pulse pattern.

Now, supposing that an output line of the inverter device for one of the three phases was short circuited to ground, the output voltage on the line shorted to ground for the one phase becomes a value close to 0 volt which is substantially a ground voltage. This is because, in a practical case of a short circuit to ground, there is a grounding fault resistance which hinders the voltage from falling to 0 volt completely. Now, given that a PWM pulse pattern that is output at this moment is vector V7, a normal average neutral point voltage value VN should be VN=Vdc, i.e., a DC voltage Vdc of the battery power supply VB. But, the voltage for the one phase on the line shorted to ground is missing and, thus, an average neutral point voltage value Vn that is detected changes to Vn=Vdc×⅔. In other words, Vdc×⅓, the voltage for the one phase on the line shorted to ground is deducted.

Then, given that the above PWM pulse pattern is vector V1, vector V3, or vector V5, a normal average neutral point voltage value VN should be VN=Vdc×⅓. But, the voltage for the one phase on the line shorted to ground is missing and, thus, an average neutral point voltage value Vn that is detected when any of vector V1, vector V3, and vector V5 is output decreases by Vdc×⅓.

Likewise, given that the above PWM pulse pattern is vector V2, vector V4, or vector V6, a normal average neutral point voltage value VN should be VN=Vdc×⅔. But, the voltage for the one phase on the line shorted to ground is missing and, thus, an average neutral point voltage value Vn that is detected when any of vector V2, vector V4, and vector V6 is output decreases by Vdc×⅓.

A case where a short circuit to ground occurs with vector 0 is left out of consideration, because all the output voltages for the three phases are 0 volt when vector 0 is output.

Next, supposing that an output line of the inverter device for one of the three phases was short circuited to a battery potential (a so-called short circuit to supply), the output voltage on the line shorted to supply for the one phase becomes Vdc which is the voltage of the battery power supply. Now, given that a PWM pulse pattern that is output at this moment is vector V0, a normal average neutral point voltage value VN should be VN=0, because all the output voltages for the three phases are 0 volt. But, the voltage for the one phase on the line shorted to supply becomes Vdc and, thus, an average neutral point voltage value Vn that is detected changes to Vn=Vdc×⅓. In other words, Vdc×⅓, the voltage for the one phase on the line shorted to supply is added.

Then, given that the above PWM pulse pattern is vector V1, vector V3, or vector V5, a normal average neutral point voltage value VN should be VN=Vdc×⅓. But, the voltage for the one phase on the line shorted to supply becomes Vdc and, thus, an average neutral point voltage value Vn that is detected when any of vector V1, vector V3, and vector V5 is output increases by Vdc×⅓.

Likewise, given that the above PWM pulse pattern is vector V2, vector V4, or vector V6, a normal average neutral point voltage value VN should be VN=Vdc×⅔. But, the voltage for the one phase on the line shorted to supply becomes Vdc and, thus, an average neutral point voltage value Vn that is detected when any of vector V2, vector V4, and vector V6 is output increases by Vdc×⅓.

A case where a short circuit to supply occurs with vector 7 is left out of consideration, because all the output voltages for the three phases are Vdc when vector 7 is output.

From this concept explained above, the abnormality determiner 230 comprised in the present embodiment detects an abnormality such as a short circuit to ground or a short circuit to supply in the output lines.

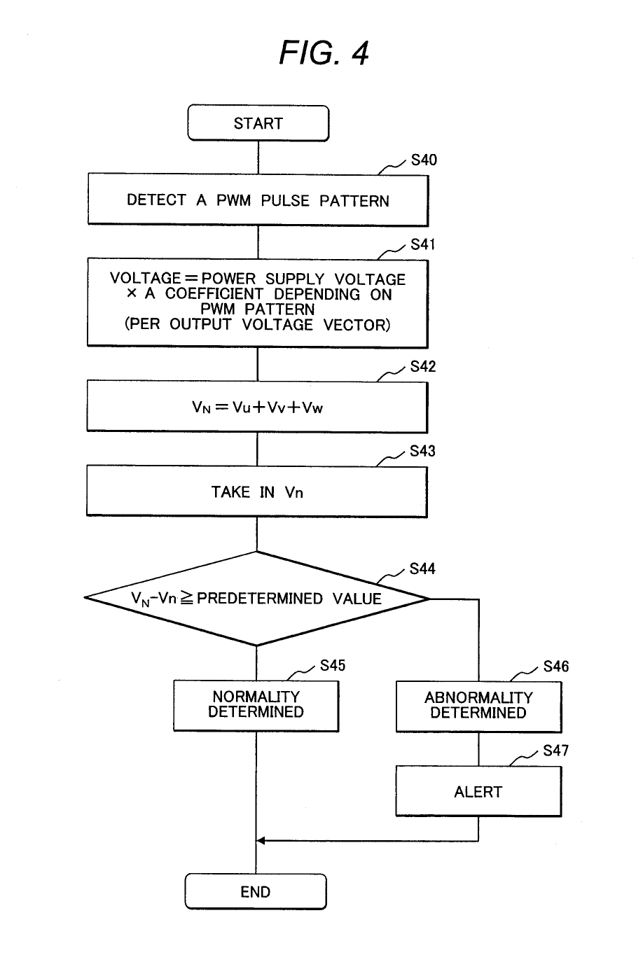

FIG. 4 presents a control flow process by which the abnormality determiner 230 determines whether an abnormality occurs. Below is an explanation about this process. This control flow process is executed by a computer and activated at given time intervals to determine whether an abnormality occurs through calculation operations which will be described below.

When the process is activated at a given time interval, it detects a PWM pulse pattern being currently output at step 40 (hereinafter, step is abbreviated to “S”). A PWM pulse pattern can be detected by a PWM carrier Carry which is a carrier wave, as mentioned previously. Depending on the PWM pulse pattern thus detected, which threshold value to be set for a normal average neutral point voltage value VN can be selected.

After a PWM pulse pattern is detected, the process goes to S41 in which it calculates voltages for the respective phases to obtain a normal average neutral point voltage value VN corresponding to the PWM pulse pattern. In this case, these voltages are obtained by multiplying the power supply voltage Vdc by a voltage coefficient for each phase based on the PWM pulse pattern.

For example, for vector V7, a voltage coefficient for all the three phases is ⅓; for vectors V2, V4, V6, a voltage coefficient for two phases is ⅓ and a voltage coefficient for the remaining one phase is 0; and, for vectors V1, V3, V5, a voltage coefficient for one phase is ⅓ and a voltage coefficient for the remaining two phases is 0.

After the voltages for the respective phases for the PWM pulse pattern are obtained at S41, the process goes to S42 in which it calculates a normal average neutral point voltage value VN. This calculation is to add the voltages for the respective phases obtained for the PWM pulse pattern, thus obtaining VN; i.e., VN is obtained by an arithmetic expression VN=Vu+Vv+Vw.

Referring to FIG. 3 (d), this normal average neutral point voltage value VN is 0 volt for vector V0, Vdc×⅓ volt for vectors V2, V4, and V6, Vdc×⅓ volt for vectors V1, V3, and V5, and Vdc volt for vector V7. This voltage value is used as a threshold value corresponding to the PWM pattern in subsequent operations.

Then, the process goes to S43 in which it takes in and stores an actual average neutral point voltage value Vn for the corresponding PWM pulse pattern from the neutral point voltage detecting circuit 120. Based on this actual average neutral point voltage value Vn and the normal average neutral point voltage value VN calculated at S42, the process makes a determination as to whether an abnormality occurs.

This determination is performed at S44 in which the process calculates a difference between the normal average neutral point voltage value VN calculated at S42 and the actual average neutral point voltage value Vn. If this difference is less than a predetermined value, the process regards it as normal. If the difference is more than the predetermined value, the process regards it as abnormal.

That is, if the difference is less than the predetermined value, the process determines that normal operation takes place, as the actual average neutral point voltage value Vn substantially matches with the normal average neutral point voltage value VN. If the difference is more than the predetermined value, the process determines that abnormal operation takes place, as the actual average neutral point voltage value Vn fluctuates with respect to the normal average neutral point voltage value VN. If the difference calculation gives a positive “+” signed or negative “−” signed difference, it will be possible to distinguish between a short circuit to ground and a short circuit to supply for the PWM pulse pattern at the moment.

In the foregoing context, a predetermined value of potential difference, which is a difference, is set depending on a resistance level to be detected. For example, this value is set to about Vdc/3, when a short circuit resistance is about 0Ω, and set to about Vdc/6, when the resistance is equivalent to the winding resistance of the motor.

Then, if a determination of normality is made at S44, the process goes to S45 in which normality is determined finally, and the control flow process is exited.

Otherwise, if a determination of abnormality is made at S44, the process goes to S46 in which abnormality is determined finally. Then, the process goes to S47 in which it executes an alert such as turning on a lamp and the control flow process is exited.

Although the foregoing process in the present embodiment calculates and obtains a normal average neutral point voltage value VN at S42 to determine whether determine whether an abnormality occurs, this determination can be made as follows. A first abnormality decision level V1, a second abnormality decision level V2, and a third abnormality decision level V3, as presented in FIG. 3 (d), are stored beforehand in a fixed memory. The process selects one of these decision levels according to the PWM pulse pattern detected and determines whether an abnormality occurs depending on an actual average neutral point voltage value Vn when the corresponding PWM pulse pattern is output.

This way of abnormality decision may be performed in the same way as the method presented in FIG. 4. In short, a normal average neutral point voltage value VN is replaced by abnormality decision levels V1 to V3.

These abnormality decision levels may be set, based on a short circuit resistance to be detected. Preferably, if these levels are set to Vdc/6, Vdc/2, and Vdc×⅚, a decision logic can be simplified in structure.

Preferably, the process may detect an average neutral point voltage value Vn and determine whether an abnormality occurs at a half cycle of a PWM carrier cycle and at timings of vector V0 and vector V7 as pointed by S1, S2, S3, S4 . . . in FIG. 3 (d).

Moreover, the process may do as above only at a timing of vector V7, if it should detect only a short circuit to ground. Furthermore, the process may determine whether an abnormality occurs at a cycle that is an integral multiple of the half cycle of a PWM carrier cycle.

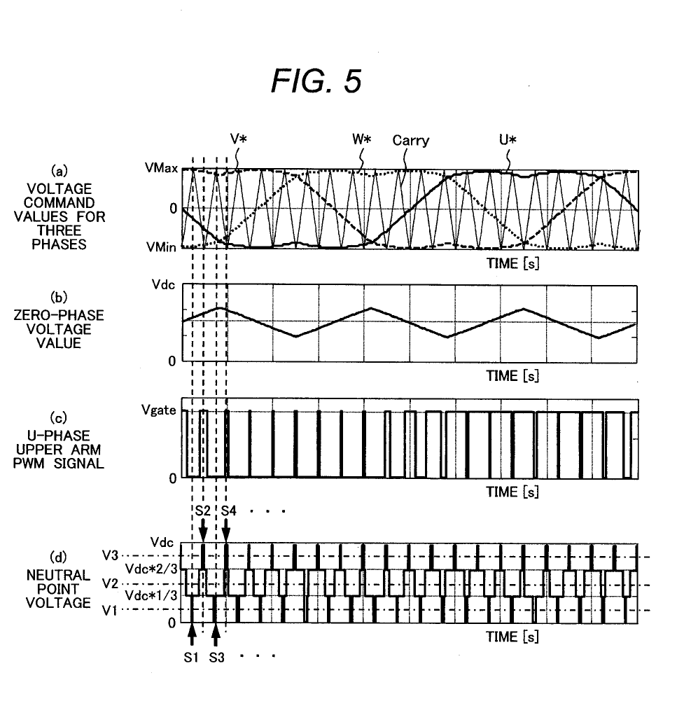

Using FIG. 5, an explanation is then provided for another set of waveform diagrams illustrating the detecting operation in the first embodiment. What differs from FIG. 3 is that the modulated waves (voltage command values) U*, V*, and W* of the inverter which are voltage command values for the three phases, presented in a section (a), have waveforms including a third harmonic and a modulation factor increased to 1.15 is applied. Accordingly, the waveform of a zero-phase voltage in a section (b) includes the third harmonic and the zero-phase voltage in the section (b) is superimposed on the waveform of a neutral point voltage in a section (d). A section (c) presents a U-phase upper arm PWM signal which operates in the same way as in the example of FIG. 3.

Even for the modulated waves including the third harmonic as presented here, the same operation as is the case for the embodiment illustrated in FIG. 3 and FIG. 4 can be accomplished.

As can be seen from this, in the case of the modulated signal including the third harmonic, a voltage fluctuation synchronous with the inverter output frequency is superimposed on the neutral point voltage of the motor. However, as presented in the section (d), it is possible to compare an average neutral point voltage value Vn at the neutral point of the motor 300 with a normal average neutral point voltage value VN in order from vector 0 to vector 7.

It is also possible to select a decision level from the first abnormality decision level V1, second abnormality decision level V2, and third abnormality decision level V3 and determine whether an abnormality occurs depending on an actual average neutral point voltage value Vn when the corresponding PWM pulse pattern is output.

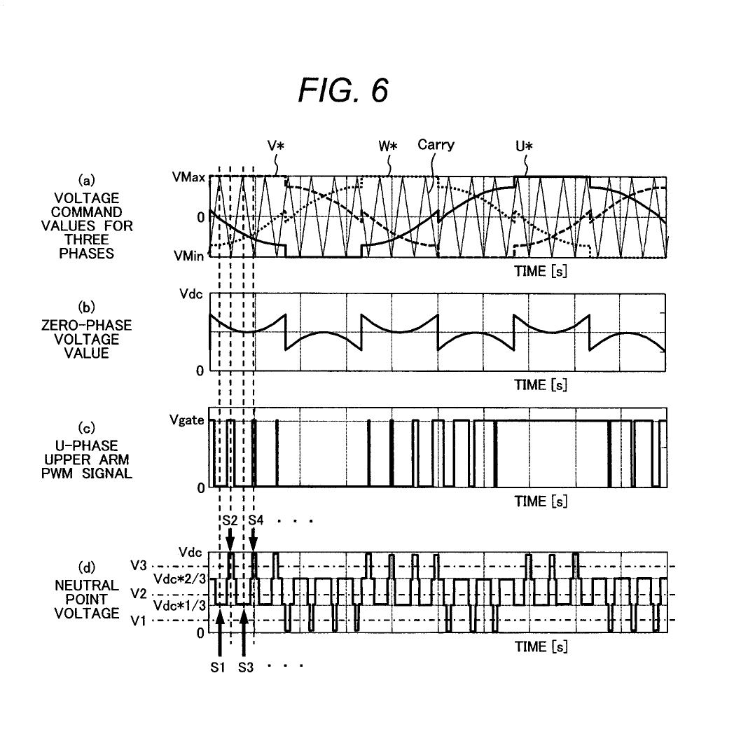

Using FIG. 6, an explanation is further provided for another set of waveform diagrams illustrating the detecting operation in the first embodiment. What differs from FIG. 3 is that the modulated waves (voltage command values) U*, V*, and W* of the inverter which are voltage command values for the three phases, presented in a section (a), have two-phase modulated waveforms and a modulation factor increased to 1.15 is applied. According to this case, the number of switching actions of the inverter can be reduced and, thus, the efficiency of the inverter can be enhanced. The zero-phase voltage in a section (b) has a waveform with Vmax in a 60-degree section and the zero-phase voltage in the section (b) is superimposed on the waveform of a neutral point voltage in a section (d).

Even for the two-phase modulated waves as presented here, the same operation as is the case for the embodiment illustrated in FIG. 3 and FIG. 4 can be accomplished.

As can be seen from this, in the case of the two-phase modulated signal, a voltage fluctuation synchronous with the inverter output frequency is superimposed on the neutral point voltage of the motor. However, as presented in the section (d), it is possible to compare an average neutral point voltage value Vn at the neutral point of the motor 300 with a normal average neutral point voltage value VN in order from vector 0 to vector 7.

If a decision level is selected from the first abnormality decision level V1, second abnormality decision level V2, and third abnormality decision level V3 and compared with an actual average neutral point voltage value Vn when the corresponding PWM pulse pattern is output, this selection may be made as follows. As presented in FIG. 6 (d), a certain number of outputs of Vdc×⅓ or less, pointed by S1, S3, and a certain number of outputs of Vdc×⅔ or more, pointed by S2, S4 are repeated alternately. Thus, by recognizing and determining which of these outputs, a selection may be made between the first abnormality decision level V1 and the third abnormality decision level V3.

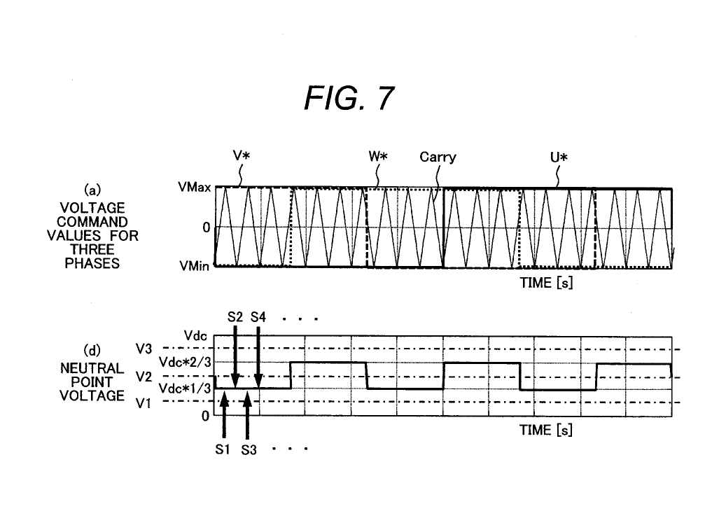

Using FIG. 7, an explanation is further provided for another set of waveform diagrams illustrating the detecting operation in the first embodiment. What differs from FIG. 3 is that the modulated waves (voltage command values) U*, V*, and W* of the inverter which are voltage command values for the three phases, presented in a section (a), are 180-degree square waves and a modulation factor increased to 1.27 is applied. According to this case, the number of switching actions of the inverter can be reduced and, thus, the efficiency of the inverter can be more enhanced than in the case presented in FIG. 6. A zero-phase voltage in a section (b) and a U-phase upper arm PWM signal in a section (c) are not presented here. The waveform of a neutral point voltage in a section (d) is that of a square wave with a 60-degree cycle.

Even for the 180-degree square wave modulated waves as presented here, the same operation as is the case for the embodiment illustrated in FIG. 3 and FIG. 4 can be accomplished.

As can be seen from this, in the case of the 180-degree square wave modulated signal, a voltage fluctuation synchronous with the inverter output frequency is superimposed on the neutral point voltage of the motor. However, as presented in the section (d), it is possible to compare an average neutral point voltage value Vn at the neutral point of the motor 300 with a normal average neutral point voltage value VN in order from vector 0 to vector 7.

In this case also, if a decision level is selected from the first abnormality decision level V1, second abnormality decision level V2, and third abnormality decision level V3 and compared with an actual average neutral point voltage value Vn when the corresponding PWM pulse pattern is output, this selection can be made as follows. As presented in FIG. 7 (d), there are no outputs of Vdc×⅓ or less, pointed by S1, S3, and no outputs of Vdc×⅔ or more, pointed by S2, S4. Thus, a determination as to whether an abnormality occurs can be made using the second abnormality decision level V2, not the first and third abnormality decision levels V1 and V3.

As described hereinbefore, in the present embodiment, an abnormality such as a short circuit to ground or a short circuit to supply can be determined, when a difference between a normal neutral point voltage value VN which depends on a PWM pulse pattern (output voltage vector) according to modulated waves and an actual neutral point voltage value Vn which depends on a PWM pulse pattern is more than or equal to a predetermined value. Thus, highly reliable abnormality detection in accordance with the waveform of the neutral point voltage is feasible. Also, stable abnormality detection not depending on the inverter output frequency is feasible.

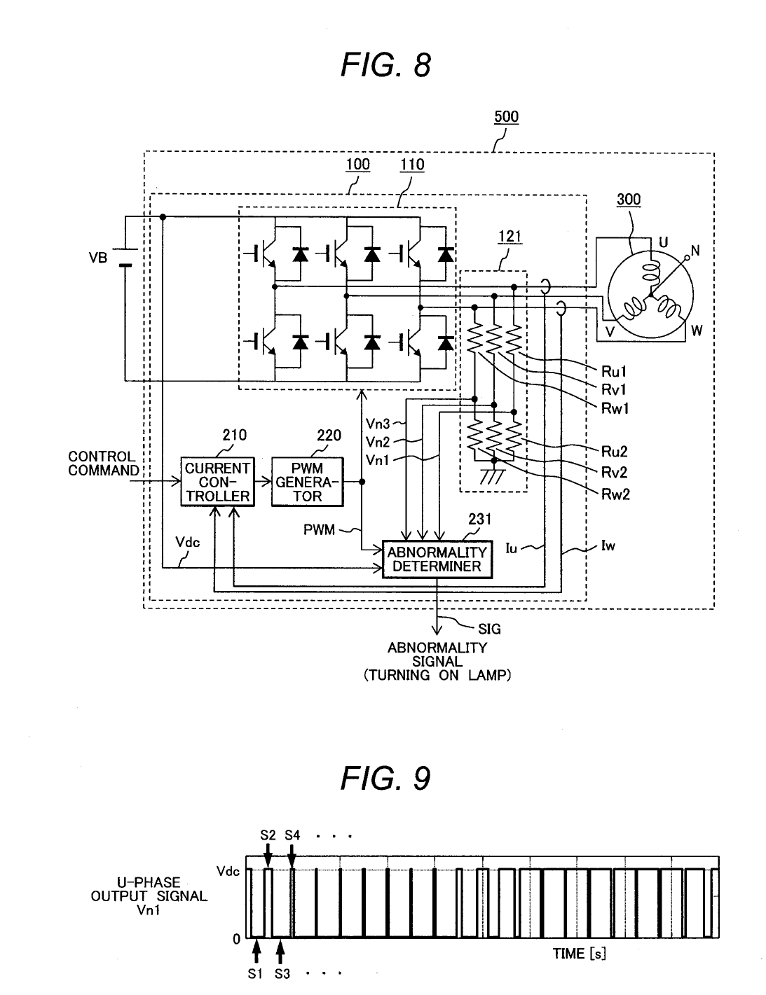

Next, a second embodiment of the present invention is described based on FIG. 8. In FIG. 8, what differs from the first embodiment is that a neutral point voltage detecting circuit 121 detects the voltages for each of the three phases (Vn1, Vn2, Vn3) and that a current detector 210 detects the currents for two phases (Iu, Iw) of the motor. Others are the same as for the first embodiment.

Particularly, the neutral point voltage detecting circuit 121 is provided with resistors Ru1, Rv1, and Rw1 and resistors Ru2, Rv2 and Rw2 serially connected to the above resistors, respectively, between each output line and ground, as presented in FIG. 8, takes in neutral point voltages across these resistors, and detects a voltage Vn1 for the U phase, a voltage Vn2 for the V phase, and a voltage Vn3 for the W phase. As an example of these voltages, FIG. 9 presents a U-phase output signal Vn1, which is a U-phase detected signal. This is also true for the V phase and W phase.

By an abnormality determiner 230, an actual average neutral point voltage value Vn is detected through a calculation according to the following equation.

Vn=(Vn1+Vn2+Vn3)/3 (2)

An actual average neutral point voltage value Vn obtained by this calculation is substituted for Vn in S43 presented in FIG. 4. At the next S44, the average neutral point voltage value Vn is compared with a normal average neutral point voltage value VN and a determination is made as to whether an abnormality occurs.

If an actual average neutral point voltage value Vn is detected at timings of vector V0 and vector V7 as pointed by S1, S2, S3, S4 . . . , PWM signal sampling in a condition that PWM pulse width is large is enabled and more accurate detection of an abnormal state is possible. Even in the case where the current detector 210 that detects the currents for two phases (Iu, Iw) is used, it is, of course, possible to detect an abnormality such as a short circuit to ground.

In this embodiment also, as just described, an abnormality such as a short circuit to ground or a short circuit to supply can be determined, when a difference between a normal neutral point voltage value VN which depends on a PWM pulse pattern (output voltage vector) according to modulated waves and an actual neutral point voltage value Vn which depends on a PWM pulse pattern is more than or equal to a predetermined value. Thus, highly reliable abnormality detection in accordance with the waveform of the neutral point voltage is feasible. Also, stable abnormality detection not depending on the inverter output frequency is feasible.

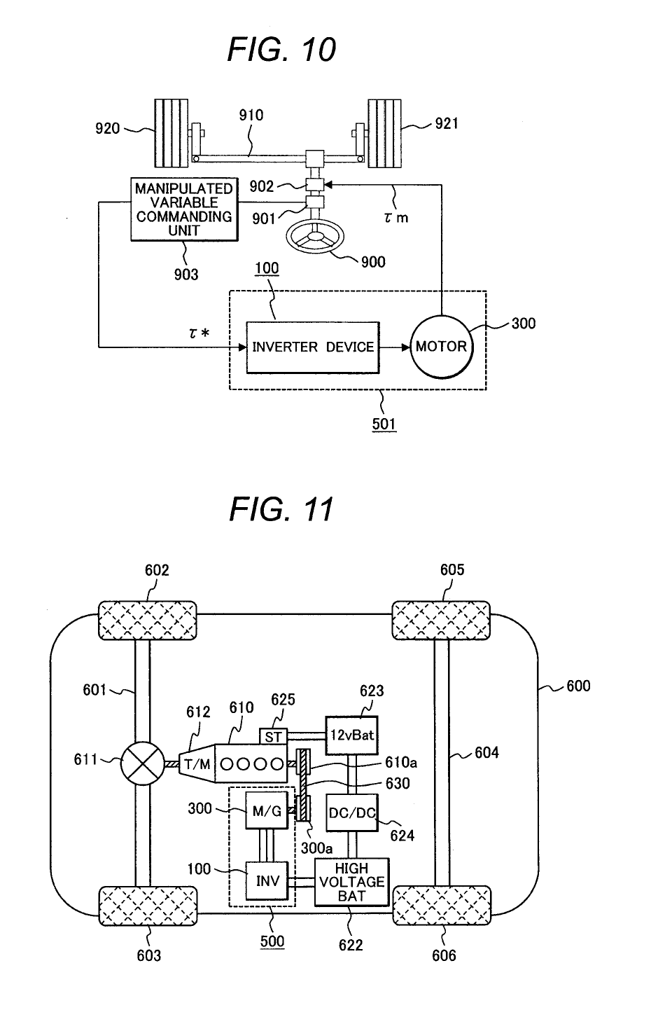

Using FIG. 10, descriptions are then provided for the structure of the motorized power steering equipment to which the motor driving control apparatus which is an embodiment of the present invention is applied.

A motorized actuator comprised in the motorized power steering equipment is comprised of a torque transmission mechanism 902 and a motor apparatus 501 (a motor 300 and an inverter device 100), as depicted in FIG. 10.

The motorized power steering equipment includes the motorized actuator, a steering wheel 900, a steering detector 901, and a manipulated variable commanding unit 903 and is configured such that, when a driver acts on the steering wheel 900, the acting force on the steering wheel 900, namely, the steering toque is assisted by way of the motorized actuator.

A torque command τ* to the motorized actuator means a steering assist toque command (which is generated by the manipulated variable commanding unit 903) for the steering wheel 900. This command is intended to reduce the force exerted by the driver on the steering wheel 900 through the use of output of the motorized actuator. The motor apparatus 501 receives a torque command τ* as an input command and controls the motor current so as to follow a torque command value based on a torque constant of the motor 300 and the torque command τ*.

A motor output τm which is output from an output shaft directly coupled to a rotor of the motor 300 transmits torque to a rack 910 of the steering equipment via the torque transmission mechanism 902 using a deceleration mechanism such as worm, wheel, and planet gears or a hydraulic mechanism. The torque thus transmitted to the rack 910 is to reduce (assist) the force exerted by the driver on the steering wheel 900 (steering force) and act on a steering angle of the wheels 920, 921.

An amount of assist is determined as follows. Parameters of acting force as a steering angle and steering torque are detected by the steering detector 901 embedded in a steering shaft to detect steering conditions. Based on these parameters with additional parameters of conditions such as a vehicle speed and a road condition, the amount of assist is determined as a torque command τ* by the manipulated variable commanding unit 903.

The motor apparatus 501 to which the present invention is applied is able to detect an abnormality of the motor such as a short circuit to ground during abrupt acceleration or deceleration of the motor and has an advantage in which safety can be enhanced.

Using FIG. 11, descriptions are then provided for the structure of a hybrid automobile system to which the motor driving control apparatus which is an embodiment of the present invention is applied.

The hybrid automobile system has a power train system to which the motor 300 is applied as a motor/generator.

In the automobile depicted in FIG. 11, a reference numeral 600 denotes a chassis and a front axle 601 is rotatably supported in the front part of the chassis 600 and front wheels 602, 603 are installed on both ends of the front axle 601. A rear axle 604 is rotatably supported in the rear part of the chassis 600 and rear wheels 605, 606 are installed on both ends of the rear axle 604.

In the center of the front axle 601, a differential gear 611 which is a power transfer mechanism is provided to distribute a rotational drive force transmitted from an engine 610 via a transmission 612 to the right and left parts of the front axle 601.

The engine 610 and the motor 300 are connected in such a way that a pulley 610a provided on a crankshaft of the engine 610 and a pulley 300a provided on a rotating shaft of the motor 300 are mechanically connected via a belt 630.

Thereby, the rotational drive force of the motor 300 can be transmitted to the engine 610 and the rotational drive force of the engine 610 can be transmitted to the motor 300. In the motor 300, the stator coils of a stator are supplied with three-phase AC power controlled by a motor driving device 100 and, thereby, a rotor rotates and generates a rotational drive force in accordance with the three-phase AC power.

That is, the motor 300 operates as a motor under control of the inverter device 100, while it operates as a generator generating three-phase AC power such that rotation of the rotor receiving a rotational drive force of the engine 610 induces an electromotive force in the stator coils of the stator.

The motor apparatus 501 is a power converter apparatus that converts DC power supplied from a high voltage battery 622 which is a power supply of high voltage (42 V or 300 V) to three-phase AC power. Three-phase AC power that flows through the stator coils of the motor 300 is controlled by the inverter device 100 according to a driving command value and depending on a magnetic pole position of the rotor.

Three-phase AC power generated by the motor 300 is converted by the inverter device 100 to DC power which charges the high voltage battery 622. To the high voltage battery 622, a low voltage battery 623 is electrically connected via a DC-to-DC converter 624. The low voltage battery 623 embodies a power supply of low voltage (14V) of the automobile and it is used as the power supply for a starter 625 that initially starts (cold starts) the engine 610, a radio, lighting, etc.

When the vehicle is at a stop for waiting for a traffic light or for other reason (in an idling stop mode), the engine 610 is stopped. When restarting (hot starting) the engine 610 to restart the vehicle, a synchronous motor 620 is driven by the motor driving device 100 and the engine 610 is restarted.

In the idling stop mode, if the high voltage battery 622 is not charged sufficiently or if the engine 610 is not warmed sufficiently, driving of the engine 610 should be continued without stopping it. In the idling stop mode, it is needed to secure a driving source for auxiliary machinery that uses the engine 610 as its driving source, such as a compressor of a air-conditioner. In this case, the synchronous motor 620 is driven to drive the auxiliary machinery.

Even when the vehicle is in an acceleration mode or a high load driving mode, the motor 300 is driven to assist the engine 610 to drive well. Conversely, when the vehicle is in a charging mode in which the high voltage battery 622 needs to be charged, the engine 610 causes the motor 300 to generate electricity to charge the high voltage battery 622. That is, an operation in a regeneration mode to be applied typically when braking or decelerating the vehicle is performed.

In such a motor apparatus for a vehicle, in case a short circuit to supply occurs in the motor, it is dangerous because a high voltage is applied. If the motor apparatus operates as the motor driving control apparatus described herein, accordingly, the vehicle can be put to maintenance at a service station promptly. There is an advantage in which a vehicle having a high reliability can be provided.

Although the case in which the motor apparatus 500 of the present invention is applied to the hybrid automobile system has been described in the foregoing embodiment, the same advantageous effect can be obtained if the same apparatus is applied to an electric automobile.

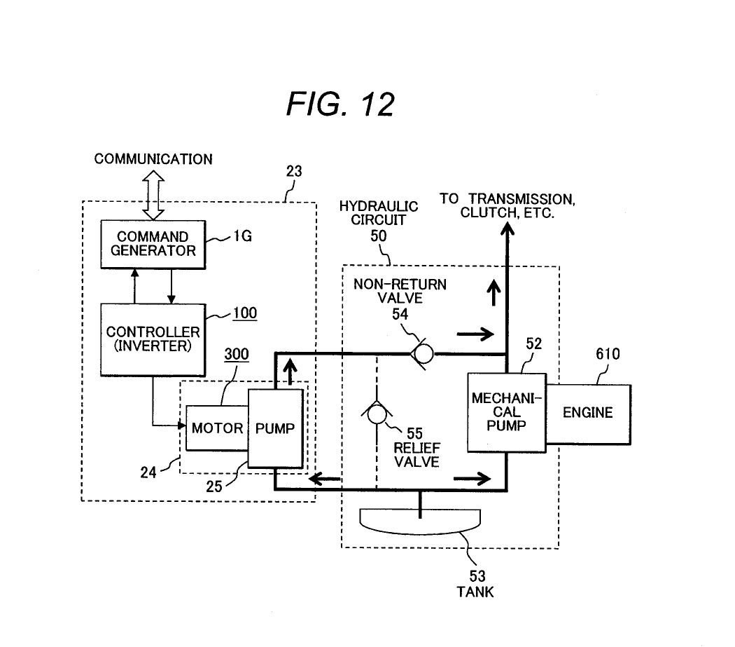

Using FIG. 12, descriptions are then provided for the structure of a motorized pump system to which the motor driving control apparatus which is an embodiment of the present invention is applied.

FIG. 12 presents a motorized hydraulic pump system that is driven during an idling stop mode of an automobile. Not only during the idling stop mode, also in an automobile whose engine is to stop completely like a hybrid automobile, this system is used to ensure the supply of hydraulic fluid to a transmission, clutch, brake, etc.

In FIG. 12, when the engine stops, hydraulic pressure in a hydraulic circuit 50 is controlled by a motorized pump 24 comprised in a motorized pump unit 23. The motorized pump 24 is driven by an inverter device 100 and the inverter device 100 is controlled by a command generator 1G.

The hydraulic circuit 50 is comprised of a mechanical pump 52 which is driven, powered by an engine 610, a tank 53 storing oil, a non-return valve 54 which prevents a backward flow from the mechanical pump 52 to the motorized pump 24, a relief valve 55, etc. The structure of the hydraulic circuit 50 is well known.

In case the discharge pressure of the motorized pump 24 is lost or becomes insufficient due to an abnormality in the output lines, there occurs a shortage of pressure in the transmission or clutch at the end of idling stop for an interval until the hydraulic pressure of the mechanical pump rises. This results in vehicle starting delay or starting shock.

It is important to detect an abnormality in the output lines and alert the driver of the abnormality before such a trouble occurs. If the motor driving control apparatus of the present invention is adopted, it is possible to surely detect an abnormality in the output lines and actions can early be taken to remedy the abnormality.

As described hereinbefore, according to the present invention, an abnormality in the output lines can be determined, when a difference between a normal neutral point voltage value VN which depends on a PWM pulse pattern (output voltage vector) according to modulated waves and an actual neutral point voltage value Vn which depends on a PWM pulse pattern is more than or equal to a predetermined value. Thus, highly reliable abnormality detection in accordance with the waveform of the neutral point voltage is feasible. Also, stable abnormality detection not depending on the inverter output frequency is feasible.

The present invention is not limited to the embodiments described previously and various changes may be made therein without departing from the spirit of the invention.

What is claimed is:

1. A motor driving control apparatus having an inverter device that controls electric power to be supplied to a motor, thus controlling and driving the motor, and output lines supplying outputs from the inverter device to the motor and extending to include windings of the motor, the motor driving control apparatus comprising:
a neutral point voltage detecting means which detects an actual neutral point voltage of the motor, the actual neutral point voltage changing in a stepwise fashion in conformity to a PWM pulse pattern output by the inverter device;
a normal neutral point voltage setting means which sets a normal neutral point voltage which depends on a PWM pattern output by the inverter device;
and an abnormality determining means which determines whether an abnormality occurs in the output lines, based on a neutral point voltage value detected by the neutral point voltage detecting means and a normal neutral point voltage value set by the normal neutral point voltage setting means.

2. The motor driving control apparatus according to claim 1,
wherein the motor is a three-phase motor provided with the windings for U, V, and W phases and the inverter device includes an inverter circuit which supplies AC power to the windings for the U, V, and W phases.

3. The motor driving control apparatus according to claim 2,
wherein the abnormality determining means obtains a difference between an actual neutral point voltage detected by the neutral point voltage detecting means and a normal neutral point voltage set by the normal neutral point voltage setting means and determines that an abnormality occurs in the output lines, if the difference is more than or equal to a predetermined value.

4. The motor driving control apparatus according to claim 2,
wherein the normal neutral point voltage setting means obtains the normal neutral point voltage by multiplying a battery power supply voltage by a predetermined coefficient which depends on a PWM pattern, thus obtaining voltages for the respective phases, and adding the obtained voltages for the respective phases.

5. The motor driving control apparatus according to claim 2,
wherein the neutral point voltage detecting means obtains the actual neutral point voltage as a voltage given by adding voltages for the respective phases detected at points midway on the output lines between the inverter circuit and the windings of the motor.

6. The motor driving control apparatus according to claim 3,
wherein the abnormality determining means determines a short-circuit to supply occurring when a voltage for at least one phase has become equal to a battery power supply voltage, when an output voltage vector of the inverter circuit is vector V0.

7. The motor driving control apparatus according to claim 3,
wherein the abnormality determining means determines a short-circuit to ground occurring when a voltage for at least one phase has become substantially equal to a ground voltage (0 volt), when an output voltage vector of the inverter circuit is vector V7.

8. The motor driving control apparatus according to claim 2,
wherein the normal neutral point voltage setting means selects one abnormality decision level from a plurality of abnormality decision levels stored beforehand in a fixed memory, according to the PWM pulse pattern, and obtains the normal neutral point voltage.

9. The motor driving control apparatus according to claim 8,
wherein the decision levels are set to a first abnormality decision level V1, a second abnormality decision level V2, and a third abnormality decision level V3, and the normal neutral point voltage setting means selects one of these abnormality decision levels, according to the PWM pulse pattern, and obtains the normal neutral point voltage.

10. The motor driving control apparatus according to claim 2,
wherein the abnormality determining means determines whether an abnormality occurs by a calculation function which is executed by a microcomputer and the calculation function comprises at least: a step of obtaining a difference between an actual neutral point voltage detected by the neutral point voltage detecting means and a normal neutral point voltage set by the normal neutral point voltage setting means; and a step of determining that an abnormality occurs in the output lines, if the difference is more than or equal to a predetermined value.
